(19) United States
(12) Patent Application Publication
(10) Pub. No.: US 2009/0144307 A1
(43) Pub. Date: Jun. 4, 2009

(54) Performing Hierarchical Aggregate Compression

(76) Inventors: Robert Joseph Bestgen, Rochester, MN (US); David Glenn Carlson, Rochester, MN (US); Robert Victor Downer, Rochester, MN (US); Shantan Kethireddy, Rolling Meadxows, IL (US)

Correspondence Address: Craig F. Taylor, 774 Randy Avenue, Shoreview, MN, 55126-2905, US

(21) Appl. No.: 11/946,945

(22) Filed: Nov. 29, 2007

(51) Int. Cl. G06F 17/30

(52) U.S. Cl. 707/102; 707/E17.005

(57) ABSTRACT

Methods, systems, and computer program products are provided for executing database rollup queries. Methods can include iterating through a database table which has been grouped and ordered on the different columns which are in the ROLLUP clause. In some embodiments, a GROUP BY ROLLUP construct can be executed while only requiring an additional one storage location per ordered column per each aggregate function to be performed on each database row. The higher level aggregate functions can be executed without relying on accessing any lower level aggregate results in some embodiments. A suitably grouped and ordered database table can have a multiple level hierarchical ROLLUP function executed in a single pass without having to retrieve lower level aggregate results.

### BACKGROUND

1. Technical Field

The field is generally related to data processing. More specifically, the field is related to methods, apparatus, and products for executing database rollup queries.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Information stored on a computer system is often organized in a structure called a database. A database is a grouping of related structures called ‘tables,’ which in turn are organized in rows of individual data elements. The rows are often referred to as ‘records,’ and the individual data elements are referred to as ‘fields.’ In this specification generally, therefore, an aggregate of fields is referred to as a ‘data structure’ or a ‘record,’ and an aggregate of records is referred to as a ‘table.’ An aggregate of related tables is called a ‘database.’

A computer system typically operates according to computer program instructions in computer programs. A computer program that supports access to information in a database is typically called a relational database management system or an ‘RDBMS.’ An RDBMS is responsible for helping other computer programs access, manipulate, and save information in a database.

An RDBMS typically supports access and management tools to aid users, developers, and other programs in accessing information in a database. One such tool is the structured query language, ‘SQL.’ SQL is query language for requesting information from a database. Although there is a standard of the American National Standards Institute (‘ANSI’) for SQL, as a practical matter, most versions of SQL tend to include many extensions. Here is an example of a database query expressed in SQL:

select * from stores, transactions
where stores.location = “Minnesota”
and stores.storeID = transactions.storeID

This SQL query accesses information in a database by selecting records from two tables of the database, one table named ‘stores’ and another table named ‘transactions.’ The records selected are those having value “Minnesota” in their store location fields and transactions for the stores in Minnesota. In retrieving the data for this SQL query, an SQL engine will first retrieve records from the stores table and then retrieve records from the transaction table. Records that satisfy the query requirements then are merged in a ‘join.’

RDBMS software typically has the capability of analyzing data based on particular columns of a table. For example, rows can be grouped according to columns defined in a GROUP BY clause of a query. The column names in a SELECT clause are either a grouping column or a column function. Column functions return a result for each group defined by the GROUP BY clause.

A grouping query can include a standard WHERE clause that eliminates non-qualifying rows before the groups are formed and the column functions are computed. A HAVING clause eliminates non-qualifying rows after the groups are formed; it can contain one or more predicates connected by ANDs and ORs, wherein each predicate compares a property of the group (such as AVG(SALARY)) with either another property of the group or a constant.

The GROUPING SET operator extends the GROUP BY operation to simultaneously specify the computation of multiple GROUP BYs in a single GROUP BY operation. When the GROUPING SET operator is used, a NULL value in a non-null grouping column denotes that the particular column is collapsed in the aggregate. If a grouping column (c) is nullable, a GROUPING operator (GROUPING(c)) is required to distinguish between the NULL group and a column collapsed in the aggregate. Used in conjunction with GROUPING SETS, the GROUPING operator returns a value which indicates whether or not a row returned in a GROUP BY answer set is a row generated by a GROUPING SET that excludes the column represented by the expression. The argument can be of any type, but must be an item of a GROUP BY clause. The result of the function is set to one of the following values: 1—The value of expression in the returned row is a null value, and the row was generated by a super-group. That is, the argument is collapsed in the aggregate. 0—The value of the expression in the returned row represents a non-system generated value of the group (which may be null and indicates that the argument is not collapsed in the aggregate.

ROLLUP operations can also be specified in the GROUP BY clause of a query. ROLLUP operations are shorthand for GROUPING SETS that represent common sets of GROUP BY operations that are required for common queries for online analytical processing (OLAP). ROLLUP grouping produces a result set containing the regular grouped rows and sub-total rows. For example, ROLLUP can provide the sales by person by month with monthly sales totals and an overall total. It should be noted that where the term “column” is used, it really could be any expression. In one example, it is common to use ROLLUP as follows: a table has a column “date” and the ROLLUP clause is GROUP BY ROLLUP (year (date), date).

May business intelligence applications involve a hierarchical, multi-dimensional aggregate view of the data. The simplest form of this is the current “group by” support which aggregates data along one dimension: e.g. state, county, city, in the following example:

select state, county, city, sales(*) from Table group by state, county, city.

In a database having columns for state, county, city, and sales, users often analyze the data in multiple ways such as further aggregate on the state and city (group by state, city) or aggregate on the overall total (no group by clause, whole file aggregate). In addition, the user may like to aggregate from a different perspective e.g. (group by county, city). With only the group by clause available, all these disparate pairings require different succinct queries. That's where the grouping sets and super groups SQL syntax comes in; grouping sets and super groups allow a user to aggregate in multiple ways in one query: This often requires performing multiple aggregates.

select state, county, city, sales(*) from Table group by grouping Sets((rollup(state, county, city)), (state, county), (county)).

What would be desirable is a method for performing the multiple aggregates in a more efficient manner.

### SUMMARY

Methods, systems, and computer program products are provided for executing database rollup queries. Embodiments typically include iterating through a database table which has been grouped and ordered on at least two different columns. This grouping may be done through use of SQL GROUP BY and ORDER BY statements. Some embodiments of the invention provide an efficient implementation of SQL GROUP BY ROLLUP statements. Data is sorted over all columns (expressions) in the ROLLUP clause. E.g. if there are three columns in the ROLLUP clause, data is sorted over all three columns.

Various aggregate functions can be performed on the date. One aggregate function is the summation function or sum, used in the present application for illustration purposes. In some embodiments, the GROUP BY ROLLUP construct can be executed while only requiring an additional one storage location per ordered column per each aggregate function to be stored for each database row. The higher level column aggregate functions can be executed without relying on accessing any lower level column aggregate results in some embodiments. In other embodiments, the higher level column aggregate functions can be executed while relying on no more than one lower level column aggregate function result. A suitably grouped and ordered database table can have a multiple level hierarchical ROLLUP function executed in a single pass without having to retrieve lower level column aggregate results.

The query described in the background section defines 4 grouping sets (state, county, city), (state, county), (state), and ( ). Other prior art DB Engines perform the 4 aggregates in 4 separate legs, using up to 4 temporary result sets. Some embodiments of the present invention provide the ability for the RDMS to perform the four aggregates hierarchically using at most 1 temporary result set. One example utilizes a MultiAggregate node which takes as input, data from the table sorted by state, county, city. All four grouping sets with aggregate can be computed by stacking each individual aggregate where one level may use the result sets from the lower level. The MultiAggregate node can use the results from each grouping stage to aggregate the next grouping levels.

```
e.g. sales(*), state, county, city
  -> sales(*), state, county
    -> sales(*),state
      -> sales(*), ( )
```

One embodiment of the invention provides a method for performing a rollup function on a database table, wherein the database table is grouped by and ordered on at least a first level column and a second level column, where as between the first level column and second level column the database table is grouped by and ordered primarily on the second level column and secondarily on the first level column. The database table also has a quantity column upon which an aggregate function can be performed to produce an aggregate result. This embodiment method includes generating first level aggregate results for at least one first level column value, generated responsive to a change in the first level column values between successive rows. The method also includes generating second level aggregate results for at least one second level column value, generated responsive to a change in the second level column values between successive rows, wherein generating each second level aggregate result does not require more than one first level aggregate result. In some methods, generating each second level aggregate result does not require accessing any first level aggregate result.

Some embodiment methods also include outputting the first level aggregate results; and outputting the second level aggregate results. Methods may also include generating an overall aggregate result responsive to the data ending, in which the overall aggregate result includes an aggregate for all rows in the database table.

In some embodiments, the database table is further grouped by and ordered on at least a third level column, where as between the second level column and the third level column the database table is grouped by and ordered primarily on the third level column and secondarily on the second level column. The embodiment method can further include generating third level aggregate results for at least one third level column value, generated responsive to a change in the third level column values between successive rows, wherein generating each third level aggregate result does not require accessing more than one second level aggregate result. In some embodiments methods, generating each third level aggregate result does not require accessing any second level aggregate result.

In some embodiments of the invention, an aggregate store exists for each level, and the aggregate store for each level is refreshed responsive to accessing a new row having a quantity value. The aggregate store for each level is refreshed from an immediately lower level aggregate store prior to the lower level aggregate store resetting in some methods. Methods according to the present invention may include iterating through a previously grouped and sorted database table and/or a previously indexed database table.

The present invention also provides systems for processing database queries, where such a system can include a computer processor and a computer memory operatively coupled to the computer processor. The computer memory can have disposed within it computer program instructions capable of performing the various methods according to the present invention.

Computer program products for processing database queries are also provided by the present invention. Such a computer program product can be disposed in a computer readable signal bearing medium, the computer program product comprising computer program instructions capable of performing the various methods according to the present invention.

The foregoing and other benefits, features and aspects of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 illustrates one computer hardware environment of the present invention.

FIG. 2 is a flowchart illustrating the steps which can be used for the interpretation and execution of SQL statements in an interactive environment according to the present invention.

FIG. 3 is a database table which can be operated on by a GROUP BY ROLLUP function.

FIG. 4 is high level pseudo code example which is used to illustrate one embodiment of the invention.

FIG. 5 is an illustration the result of performing a GROUP BY ROLLUP function on the database table of FIG. 3.

### DETAILED DESCRIPTION OF EXEMPLARY EMBODIMENTS

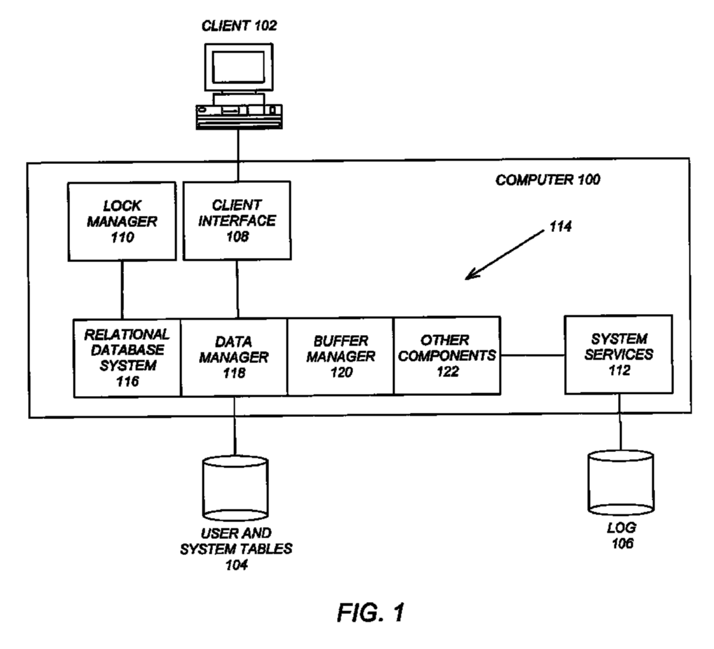

FIG. 1 illustrates an exemplary computer hardware and software environment that could be used with the present invention. In the exemplary environment, a server system 100 is connected to one or more client systems 102, in order to manage one or more databases 104 and 106 shared among the client systems 102.

Operators of the client systems 102 can use a standard operator interface 108, such as IMS/DB/DC CICS, TSO, OS/2 or other similar interface, to transmit electrical signals to and from the server system 100 that represent commands for performing various search and retrieval functions, termed queries, against the databases. In some embodiments of the present invention, these queries may conform to the Structured Query Language (SQL) standard, and invoke functions performed by Relational DataBase Management System (RDBMS) software. In one embodiment of the present invention, the RDBMS software comprises the DB2 product offered by IBM for the MVS, UNIX, WINDOWS or OS/2 operating systems. Those skilled in the art will recognize, however, that the present invention has application to any RDBMS software.

As illustrated in the example of FIG. 1, the DB2 product can include three major components: the Resource Lock Manager (RLM) 110, the Systems Services module 112, and the Database Services module 114. The RLM 110 handles locking services, because DB2 treats data as a shared resource, thereby allowing any number of users to access the same data simultaneously, and thus concurrency control is required to isolate users and to maintain data integrity. The Systems Services module 112 controls the overall DB2 execution environment, including managing log data sets 106, gathering statistics, handling startup and shutdown, and providing management support.

At the heart of the DB2 architecture is the Database Services module 114. The Database Services module 114 contains several submodules, including the Relational Database System (RDS) 116, the Data Manager 118, and the Buffer Manager 120, as well as other elements such as an SQL compiler/interpreter. These submodules support the functions of the SQL language, i.e., definition, access control, retrieval, and update of user and system data.

Generally, each of the components, modules, and submodules of the RDBMS software comprise instructions and/or data, and are embodied in or retrievable from a computer-readable device, medium, or carrier, e.g., a memory, a data storage device, a remote device coupled to the server computer 100 by a data communications device, etc. Moreover, these instructions and/or data, when read, executed, and/or interpreted by the server computer 100, cause the server computer 100 to perform the steps necessary to implement and/or use the present invention.

Thus, the present invention may be implemented as a method, apparatus, or article of manufacture using standard programming and/or engineering techniques to produce software, firmware, hardware, or any combination thereof. The term “article of manufacture”, or alternatively, “computer program product”, as used herein is intended to encompass a computer program accessible from any computer-readable device, carrier, signal, or media.

Of course, those skilled in the art will recognize many modifications may be made to this configuration without departing from the scope of the present invention. Specifically, those skilled in the art will recognize that any combination of the above components, or any number of different components, including computer programs, peripherals, and other devices, may be used to implement the present invention, so long as similar functions are performed thereby.

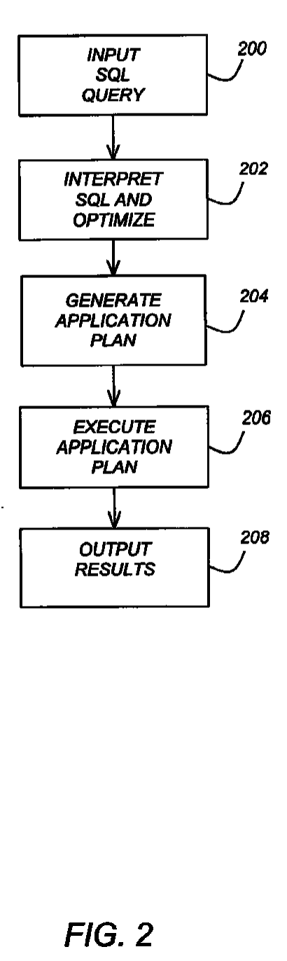

FIG. 2 is a flowchart illustrating steps which can be used for the interpretation and execution of SQL statements in an interactive environment according to the present invention. Block 200 represents the input of SQL statements into the server system 100. Block 202 represents the step of compiling or interpreting the SQL statements. An optimization function within block 202 may transform or optimize the SQL query in a manner described in more detail later in this specification. Generally, the SQL statements received as input specify only the desired data, but not how to retrieve the data. This step considers both the available access paths (indexes, sequential reads, etc.) and system held statistics on the data to be accessed (the size of the table, the number of distinct values in a particular column, etc.), to choose what it considers to be the most efficient access path for the query. Block 204 represents the step of generating a compiled set of runtime structures called an application plan from the compiled SQL statements. Block 206 represents the execution of the application plan and Block 208 represents the output of the results.

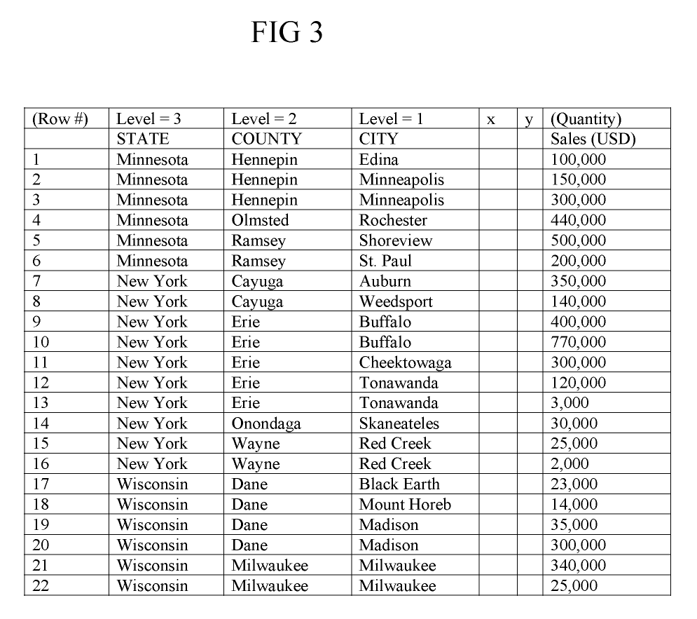

FIG. 3 includes a database table having 22 rows and three different columns corresponding to the levels in the GROUP BY function. A quantity column is included, here having a sales figure in dollars. More than one quantity type column may be present in some embodiments of the invention. Two columns, denoted as “X” and “Y” are shown to indicate that there may be additional columns present in the table being operated upon that may not be utilized in the GROUP BY ROLLUP function and may be ignored in processing. FIG. 3 illustrates a GROUPED and ORDERED table. The levels are numbered to proceed from lowest to highest, in order to avoid confusion when the “lowest” level is referred to. Here, the lowest column level is said to have a value of 1. All such tables would have a lowest level value, for example, 1, but may have different levels of grouping, for example, greater than 3 in certain uses of the invention.

In FIG. 3, the lowest level column is the city column or level 1, followed by the county column or level 2, followed by the highest level column which is the state column or level 3. As between the first and second level columns, the table is grouped and ordered primarily on level 2 and secondarily on level 1. As between the third and second level columns, the table is order primarily on level 3 and secondarily on level 2. This hierarchy can continue further up to fourth levels, fifth levels, etc.

In some embodiments of the invention, the table of FIG. 3 may be a virtual table or a temporary table output from a preceding SQL command. In some embodiments, FIG. 3 illustrates a table as it may be stored in the database. In other embodiments, the table of FIG. 3 may be generated by maintaining permanent or temporary indices or other sorting aids on the level 1, 2, and 3, columns as illustrated in FIG. 3. The table of FIG. 3 may be generated by a GROUP BY SQL statement of the form GROUP BY (state, county, city). In this example and that FIG. 3, the lowest level, level 1 is the city, the next highest level is level 2, the county, and the next higher level is level 3, the state.

In the GROUP BY ROLLUP function which is described in more detail below, the rows may be viewed as being iterated through or indexed through. Within this looping through the rows, the levels 1, 2, and 3 may also be viewed as being indexed through as the aggregate function is being calculated on the data base table data. In most embodiments, the row will be increased continually in an outer loop as the method progresses through the table. In some embodiments, the current column level being iterated can increase from one to two to three and then back again to one in an inner loop. This can happen repeatedly throughout the table analysis.

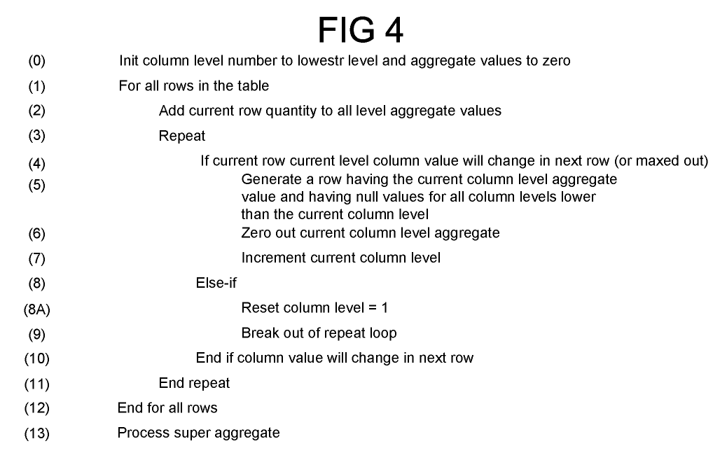

FIG. 4 illustrates an algorithm illustrated in a high level pseudo-code which has been overly simplified for the purposes of illustrating one embodiment of the present invention. As previously discussed, the city column is considered the lowest level column, and the current column level may be iterated through from 1 to 3 repeatedly as the rows are also iterated through. In the example discussed here, the aggregate function is a sum function. This is for the purposes of illustration only. In other embodiments, the aggregate function may be a sum, a ratio of two or more column values, an average, a statistical analysis, and the like. Thus, the aggregate function can be some function which is dependent upon the quantity of one or more columns in the database.

Some embodiments of the present invention depend upon the table being GROUPED BY and SORTED according to the levels to be operated upon by the GROUP BY ROLLUP function. This grouping and ordering can be the result of the temporary output generated by other SQL commands or can reflect the actual storage state of the database. As previous discussed, this can also be accomplished using indices or other sorting methods well known to those skilled in the database art.

In some embodiments of the present invention, the current level being operated on is initialized to the lowest level, for example, 1 which corresponds here to the city column. The value of the aggregate functions, for example, the sums, can be initialized to zero for each level and, in some embodiments, also to zero for a super aggregate function value. This super aggregate function value can be, for example, the total of all the quantity values present in the quantity column for the entire table. In this example of the invention, there would be a super level containing the sum of all the sales in the entire table.

The table FIG. 3 can be iterated through by incrementing the value for the row number. The row number is provided in the present example primarily to illustrate the present invention and allow for discussion of the table in the text. The example algorithm may be best explained by processing the table FIG. 3. The row 1 quantity is 100,000, which occurred in a location in the city of Edina. This value can be added to the sum for level 1, the city level, and to the sum for level 2, the county level, and to the sum for level 3, the state level. As previously discussed, the sum function is used as an example of an aggregate function. In other embodiments, discussed below, only the lowest level sum function, the city sum, is added to for each new value obtained from a newly accessed row. This sum can later be added to the next higher level sum, for example, level 2, the county level, at the appropriate time in the algorithm. In this example, in the pseudo code of FIG. 4, we will consider that the newly obtained quantity from the current row is being added to the aggregate or sum function for all three levels soon after the quantity value is obtained from the current row, as this simplifies the explanation of this embodiment of the present invention.

At this point in the algorithm, in some embodiments, the algorithm looks ahead (at line 5 in FIG. 4) to the next row to determine if the value of the current level column will be the same. For row number 1, the current level column under consideration is the city at level 1, and the algorithm would peek ahead to see if the city value will be the same in the next row. In this case, the city will change from Edina to Minneapolis, and therefore the next row level value will not be the same. This same logic can be used to determine the end of table or end of file condition, as the value for the current level under consideration will not be the same if the table is going to end.

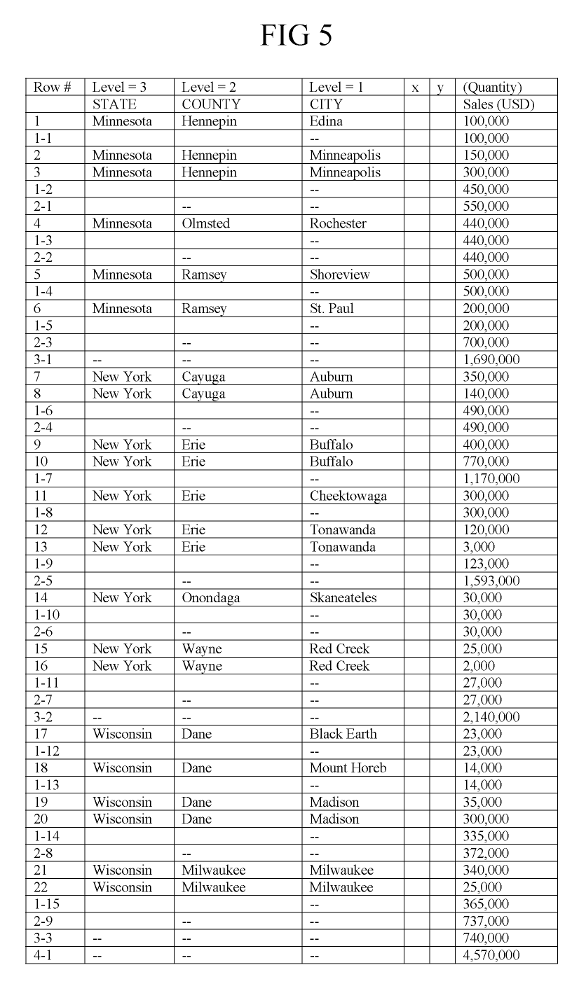

As the value for level 1, the city, will not be the same in the next row, then the method can generate and output a row having the sum for the current level shown. In this example, the aggregate function value or the sum value for the city column is the same as that for Edina, which is 100,000, as there was only one city before the next city would change. In addition, in some embodiments of the invention, rows generated and output can also include a null value for all columns at and below the level of the current level column. As the current level column here is 1, there are no such lower-level columns and only the current level column, the level 1 column for cities is a null. In FIG. 5, a dash “-” denoting a null value may be seen in the city column to marked as row 1-1, referring to level 1, aggregate 1. The first aggregate is the same as the value of sales in the city of Edina, 100,000.

In line 6 of the FIG. 4 pseudo code, the current level aggregate value is zeroed out, corresponding to zeroing out the city aggregate value. As indicated at line 7 of the pseudo code, the current level being considered can be incremented to level 2, corresponding to the county level. The end repeat indicated at line 11 will be reached, forcing execution back to line 3, forcing a check of whether the county is going to change in the next row As this is not the case, the else if function at line 8 is reached, causing a break at line 9, which exits the repeat loop bounded by line 11. As indicated at line 8A. the current level being considered can be reset to the lowest level of 1.

Row 2 is now under consideration. The aggregate value for city has been previously reset to zero, and now has the value of 150,000 added to it for the city of Minneapolis. Looking ahead (in line 4) to the next row's column value for level 1, the city level, we see there will be no change, therefore the row is incremented and the 300,000 quantity is added to the city level 1 aggregate value. With row 4 being inspected, the city value will indeed change for level 1, and therefore the logic at line 5 can be executed, outputting the current city level aggregate of 450,000, along with a null indicator for the city column. The city level aggregate can then be zeroed at line 6. The current level under consideration can be incremented at line 7 of the pseudo code, forcing the logic to also peek ahead to the county value for row 4, which is also going to change. Therefore the output function at line 5 is executed, out putting a second aggregate row labeled as row 2-1 in FIG. 5, corresponding to level 2, output 1. FIG. 5, Row 2-1, outputs the total for Hennepin County which has been added to since the beginning of the table. This value is 550,000 and includes a null indicator output for level 2, the county level. This also and can include a null output for all levels lower than the county, which means the city column at level 1. The current level being considered is incremented at line 7, the logic at line 4 checks for a change in level 3, the state level, which is not found to change in the next row. Therefore, the column level for consideration is set to 1 at line 8A. and line 4 is reached. At this point, the aggregate values for city and county have both been zeroed out.

In evaluating row 4, the 440,000 value for Rochester is added to the city, county, and state aggregate values. In looking ahead to row 5, the city in level 1 will change, forcing the city aggregate of 440,000 to be output along with a null indicator for the city as previously described. As the county will change from Olmsted to Ramsey, this will also force a county totalization which is also 440,000. A null indicator is output for both county and city columns, as previously described. With row 5 being evaluated, there is one and only one value for the city of Shoreview, forcing a city totalization to output at FIG. 5 row 1-4, of 500,000. This also generates a null output for city, as previously described. As the county does not change in evaluating row 6, row 6 will be processed, then causing a look ahead to row 7. Row 7 does have a different city value, forcing a city total of 200,000 be output together with a null value for city in row 1-5 of FIG. 5. The look ahead for county is also not going to result in the same county value, forcing a county totalization output of 700,000 together with null indicators for both county and city, at row 2--3. In looking ahead for level 3, the state level, the state value will also not be the same, forcing a state totalization output at row 3-1 of 1,690,000. This is also accompanied by a null indicator for level 3, the state level, together with null indicators output for the lower levels of county and city, as shown in row 3--1. As the logic in line 4 of the pseudo code can include a check for the level being maxed out, this can be treated as if the current level column value is maxed out, and the current level being considered can be reset to 1 as indicated at line 8A.

Row 7 can bow be processed, followed by row 8, generating a city aggregate output row at 1--6 for Auburn, and a county output for Cayuga County at 2-4. Rows 9 and 10 can be processed, generating a total for the city of Buffalo at row 1--7. Processing continues, adding a city total for Cheektowaga at row 1--8 and a total for the city of Tonawanda at row 1--9. A total for Erie County may be seen at row 2--5. City and county totals for Skaneateles (city) and Onondaga County are generated at row 1--10 and row 2-6, respectively. After generating county and city totals for Wayne County and the city of Red Creek at rows 1--1 and 2--7, a look ahead to row 17 shows that the state will change as well. This generates a row output at row 3--2 for the state of New York as well.

The processing for the state of Wisconsin continues for rows 17 through 22, forcing a city output for Milwaukee at row 1--16, a county output for the County of Milwaukee at row 2-9, and a state output for the state of Wisconsin at row 3-3.

At this point in the processing, all the rows in the table have been processed, reaching execution of the pseudo-code line 13. This line can simply output the aggregate values for the super aggregate which may be considered as a level 4 aggregate, together with the null indicators for state, county, and city, as seen in row 4-1. This super aggregate can be added to every time a new row is processed, or at an appropriate time in the logic before the state aggregate is reset to zero, which would happen at the point of a change in the state column value in some embodiments.

The aggregate values, here the sum values, have been intermixed with the table of FIG. 3, to produce FIG. 5. This has been done to correlate to the aggregate values with the sorted table of values. In some embodiments, the output can follow this convention. In other embodiments, the output results can be generated in a single, separate table. In still other embodiments, this single table may effectively be appended to the end of the current table. In still other embodiments, a separate result table may be generated for each level of aggregate requested. For example, a separate super aggregate, a state aggregate, county aggregate, and city aggregate table can be produced, for a total of four separate tables.

Inspection of FIG. 5 shows that the aggregate values can be arrived at in different ways. In one possible, prior art method, to arrive at the super aggregate level shown in row 4--1, the entire table could be iterated through again, and the value in the quantity or sales column repeatedly processed, once for each row, to arrive at the super aggregate level shown in role 4--1. This is seldom done in practice because of the wasteful use of resources. In another, prior art method, the level 1 aggregates, the city aggregates, could be generated and stored. Then the city aggregates could be retrieved and operated on to produce a county level aggregates. Then the county level aggregates could be operated upon to form the state aggregates. Finally, the state aggregates could be operated upon to form the super aggregate value, here, the sum of all sales. Thus, the super aggregate would be produced by accessing all of the state aggregates, and the county aggregates produced by accessing all of the city aggregates. This prior art method, while not a wasteful as iterating through the entire table once for each level of aggregate, is not as efficient as the method provided by the present invention. By making use of the grouped and sorted nature of the input table, the input table need not be iterated through again, in most embodiments of the present invention. In some embodiments of the present invention, there are only 4 additional storage locations required to store the multiple aggregate or sum quantities shown FIG. 5. In such embodiments, one storage object stores the city aggregate, the second a county aggregate, the third the state aggregate, and the forth the super aggregate. These storage locations can be local variables which are often cheap to access. In some embodiments of the present invention, both the need to access the input database table is significantly reduced as are the storage requirements for maintaining multiple levels of stored values, for example, the intermediate level aggregates upon which the higher level aggregates depend in some prior art methods.

In various embodiments of the present invention, various algorithms may be used. In one embodiment, the higher level aggregate storage values are incremented or added to only when the lower level aggregates are going to be set to zero. In some embodiments, as one previously described, the higher level aggregates can be added to or changed when obtaining a new quantity column value, retrieved for every row having a non-null value. Various methods can be used to indicate that the output row is a level 1 aggregate output, or a level 2 or a level 3 aggregate output. Some embodiments of the invention, as illustrated with respect to FIG. 5, can use a null indicator output. In other embodiments, other indicators are used. In particular, some methods utilize an indicator for the aggregate output which is different from the null value, as this could be found in some columns as values, for example, sales in a county which was not within any city.

Other embodiments of the invention utilize methods which obtained a row column value and then look back rather than look ahead to detect a change in column value. Some embodiments operate on input tables which are grouped by and sorted for the rollup levels, and also have extra, extraneous data within. In the example of FIG. 5, this is represented by the columns denoted by . and Y. In other embodiments, only the columns necessary for the GROUP BY ROLLUP are present in the database table.

The summation function has been used as an example with respect to FIG. 5. In other embodiments, other aggregate functions could be generated. In one example, the columns denoted by X could contain the number of stores and the value output could output not only the total sales but the sales per store. The use of the sum as an aggregate function is intended to illustrate and not limit the present invention.

What is claimed is:

1. A method for performing a rollup function on a database table, wherein the database table is grouped by and ordered on at least a first level column and a second level column, where as between the first level column and second level column the database table is grouped by and ordered primarily on the second level column and secondarily on the first level column, and in which the database table has a quantity column upon which an aggregate function can be performed to produce an aggregate result, the method comprising:
generating first level aggregate results for at least one first level column value, generated responsive to a change in the first level column values between successive rows; and
generating second level aggregate results for at least one second level column value, generated responsive to a change in the second level column values between successive rows,
wherein generating each second level aggregate result does not require more than one first level aggregate result.

2. The method of claim 1, in which generating each second level aggregate result does not require accessing any first level aggregate result.

3. The method of claim 1, further comprising:
outputting the first level aggregate results; and
outputting the second level aggregate results.

4. The method of claim 1, further comprising generating an overall aggregate result responsive to the data ending, in which the overall aggregate result includes an aggregate for all rows in the database table.

5. The method of claim 1, wherein the database table is further grouped by and ordered on at least a third level column, where as between the second level column and the third level column the database table is grouped by and ordered primarily on the third level column and secondarily on the second level column, the method comprising:
generating third level aggregate results for at least one third level column value, generated responsive to a change in the third level column values between successive rows;
wherein generating each third level aggregate result does not require accessing more than one second level aggregate result.

6. The method of claim 5, in which generating each third level aggregate result does not require accessing any second level aggregate result.

7. The method of claim 1, in which an aggregate store exists for each level, and in which the aggregate store for each level is refreshed responsive to accessing a new row having a quantity value.

8. The method of claim 1, in which an aggregate store exists for each level, and in which the aggregate store for each level is refreshed from an immediately lower level aggregate store prior to the lower level aggregate store resetting.

9. The method of claim 1, in which the method includes iterating through a previously grouped and sorted database table.

10. The method of claim 1, in which the method includes iterating through a previously indexed database table.

11. A system for processing database queries, the system comprising a computer processor, a computer memory operatively coupled to the computer processor, the computer memory having disposed within it computer program instructions capable of performing a rollup function on a database table, wherein the database table is grouped by and ordered on at least a first level column and a second level column, where as between the first level column and second level column the database table is grouped by and ordered primarily on the second level column and secondarily on the first level column, and in which the database table has a quantity column upon which an aggregate function can be performed to produce an aggregate result, the method comprising:
generating first level aggregate results for at least one first level column value, generated responsive to a change in the first level column values between successive rows; and
generating second level aggregate results for at least one second level column value, generated responsive to a change in the second level column values between successive rows,
wherein generating each second level aggregate result does not require more than one first level aggregate result.

12. The system of claim 11, in which generating each second level aggregate result does not require accessing any first level aggregate result.

13. The system of claim 11, further comprising generating an overall aggregate result responsive to the data ending, in which the overall aggregate result includes an aggregate for all rows in the database table.

14. The system of claim 11, in which an aggregate store exists for each level, and in which the aggregate store for each level is refreshed responsive to accessing a new row having a quantity value.

15. The system of claim 11, wherein the database table is further grouped by and ordered on at least a third level column, where as between the second level column and the third level column the database table is grouped by and ordered primarily on the third level column and secondarily on the second level column, the method further comprising:
generating third level aggregate results for at least one third level column value, generated responsive to a change in the third level column values between successive rows;
wherein generating each third level aggregate result does not require accessing more than one second level aggregate result.

16. A computer program product for processing database queries, the computer program product disposed in a computer readable signal bearing medium, the computer program product comprising computer program instructions capable of performing a rollup function on a database table, wherein the database table is grouped by and ordered on at least a first level column and a second level column, where as between the first level column and second level column the database table is grouped by and ordered primarily on the second level column and secondarily on the first level column, and in which the database table has a quantity column upon which an aggregate function can be performed to produce an aggregate result, the method comprising:
generating first level aggregate results for at least one first level column value, generated responsive to a change in the first level column values between successive rows; and
generating second level aggregate results for at least one second level column value, generated responsive to a change in the second level column values between successive rows,
wherein generating each second level aggregate result does not require more than one first level aggregate result.

17. The computer program product of claim 16, in which generating each second level aggregate result does not require accessing any first level aggregate result.
